(19) United States
(12) Patent Application Publication
(10) Pub. No.: US 2006/0181746 A1
(43) Pub. Date: Aug. 17, 2006

(54) Carrying apparatus image reading apparatus and image forming apparatus

(75) Inventor: Hideaki Sugiyama, Mishima-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/057,254

(22) Filed: Feb. 15, 2005

(51) Int. Cl. H04N 1/04

(52) U.S. Cl. 358/498

(57) ABSTRACT

A carrying apparatus comprises a carrying device which allows a medium sheet which is picked up by a pick-up device to be sandwiched by carrying roller pairs and carried at a second speed higher than at a first speed, and a driving device which has a drive source and a plurality of continuous motive power transmission gears adapted to transmit a motive power of the driving source to the pick-up roller and carrying roller pairs where, of a plurality of continuous motive power transmission gears, a motive power transmission gear connected directly to the pick-up roller is moved away from the pick-up roller based on the withdrawing of the sheet at a second speed from between the pick-up roller and a separation pad.

### BACKGROUND OF THE INVENTION

The present invention relates to a carrying apparatus, image reading apparatus and image forming apparatus which are applied to, for example, a facsimile apparatus to carry a document sheet.

In a digital copying apparatus and a facsimile apparatus having a copying function, an image reading apparatus is provided for reading a document image, generating corresponding image data and carrying the image data with the use of the public network, LAN and so on.

The image reading apparatus comprises a pick-up device for separating and picking up document sheets one by one and an image reading device for, while carrying the document sheet picked up by the pick-up device, reading the image information.

The pick-up section is so comprised as to have a pick-up roller and a separation pad set in pressure contact with the pick-up roller.

The reading section is so comprised as to have carrying roller pairs for carrying the picked-up document sheet in a sandwiched fashion and reading the document sheet carried by the carrying roller pairs.

The pick-up roller and carrying roller pairs are rotationally driven by a driving device. The driving device is so comprised as to have a single driving motor and a motive power transmission system for transmitting a motive power of the driving motor to the pick-up roller and conveying roller pairs. The motive power transmission system is so comprised as to have a plurality of continuously connected transmission gears.

Where the pick-up speed of the document sheet picked up by the pick-up roller is the same as the carrying speed at which the document is carried in a way to be sandwiched by the carrying roller pairs of the reading device, there is no space between the carrying document sheets. Therefore, the document sheets are carried in a continuously connected sheet-to-sheet unit and it is not possible to detect the document sheets one by one.

In order to secure a spacing between the document sheets, a document-reading carrying speed is made different from the document pick-up carrying speed and, by doing so, the document-reading carrying speed is made higher in speed. Since, however, the pick-up roller and carrying roller pairs are driven by the same driving motor, if the document sheet picked up by the pick-up roller reaches the carrying roller pairs and carried there in a sandwiched fashion, the document sheet is withdrawn at a higher speed than at a speed at which the document is picked up from the pick-up roller. If, in this way, the document sheet is thus withdrawn at the higher speed, then there is a risk that the step-out of the motor will occur.

In the conventional apparatus, a one-way clutch is provided on the pick-up roller and, if the document sheet is withdrawn at such higher speed, the pick-up roller is run in an idle state and the step-out of the drive motor is prevented.

In the conventional apparatus, however, the pick-up roller is run in the idle state with the use of the one-way clutch which is an expensive member and there is a high cost problem involved.

### BRIEF SUMMARY OF THE INVENTION

The present invention according to one aspect has been achieved with the above-situations in view and the object of the present invention is to provide a carrying apparatus, image reading apparatus and image forming apparatus which can run a pick-up roller in an idle state without the need to use any one-way clutch which is an expensive member.

In one aspect of the present invention, there is provided a carrying apparatus comprising a pick-up device which allows medium sheets to pass between a pick-up roller and a separation pad set in pressure contact with the pick-up roller and, by doing so, separates and picks up the sheets one by one at a first speed; a carrying device which allows the sheet which is picked up by the pick-up device to be sandwiched by carrying roller pairs and carried at a second speed higher than at said first speed; and a driving device which has a driving source and a plurality of continuous motive power transmission gears adapted to transmit a motive power of the driving source to the pick-up roller and carrying roller pairs where, of said plurality of continuous motive power transmission gears, a motive power transmission gear connected directly to the pick-up roller is moved away from the pick-up roller based on the withdrawing of the sheet at said second speed from between the pick-up roller and the separation pad.

The above-mentioned carrying apparatus can be applied to an image reading apparatus, such as a scanner, and an image forming apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is an external, perspective view showing a facsimile apparatus according to one embodiment of the present invention;

FIG. 2 is a longitudinal side view showing an inner structure of the facsimile apparatus;

FIG. 3 is a view showing a structure of a driving device for a pick-up device and reading device;

FIG. 4 is a plan view showing a contactable gear mounting structure of a motive power transmission device;

FIG. 5 is a plan view showing a mounting structure of the contactable gears; and

FIG. 6 is a view showing a state in which the contactable gear is moved away from a gear of the pick-up roller.

### DETAILED DESCRIPTION OF THE INVENTION

The embodiment of the present invention will be described below with reference to the drawing.

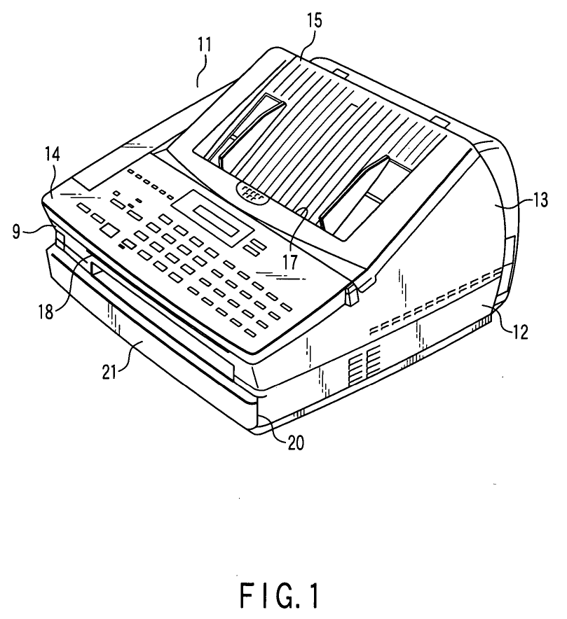

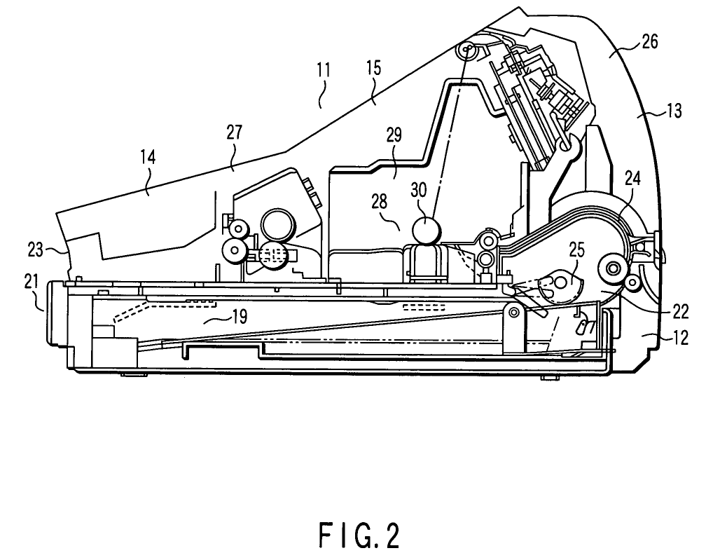

FIG. 1 is an outer, perspective view showing a facsimile apparatus according to one embodiment of the present invention and FIG. 2 is a longitudinal side cross-sectional view of it.

The facsimile apparatus has an apparatus body 11, and the apparatus body 11 comprises a lower case 12 and an upper case 13 which is covered over the lower case 12.

An operation panel 14 is provided on the upper surface of the upper case 13 and a document rest 15 is located in an inclined state on the rear side of the operation panel 14 to allow a document to be set there.

The upper case 13 has a document insertion section 17 formed continuous with the document rest 15 and a document discharge outlet 18. The document insertion section 17 is connected through a later-described document sheet carrying path 32 to the document discharge outlet and a document image reading device 4 is provided at the document sheet carrying path 32.

A cassette insertion section 19 is provided in the lower case 12 and a sheet supply device 21 is inserted into, and withdrawned out of, the cassette insertion section 19.

A recording sheet delivery hole 22 is provided in the lower case 12 at a rear side of the cassette insertion section 19. A recorded sheet discharge outlet 23 is provided at the front surface portion of the lower case 12. The recording sheet delivery hole 22 communicates with a recorded sheet discharge hole 23 through the sheet path 24. At the upper portion of the rear side of the sheet supply device 21, a delivery roller 25 is provided to allow the sheets which are set on the sheet supply device 21 to be delivered one by one.

An image forming device 26, a fixing section 27, etc., are sequentially arranged at the sheet path 24 along a sheet supply direction. A drum unit 28 and photoelectric developing unit 29, etc., are provided in the image forming device.

In the image forming section 26, an outer peripheral surface of a photoelectric drum 30 in the drum unit 28 is electrically charged to provide an electrostatic latent image of a recording pattern on the outer peripheral surface of the photoelectric drum 30. A toner is applied by the photoelectric developing unit 29 to the electrostatic latent image on the photoelectric drum 30 and it is transferred to the sheet. The toner image thus transferred to the sheet is heated and fixed by the fixing section 27.

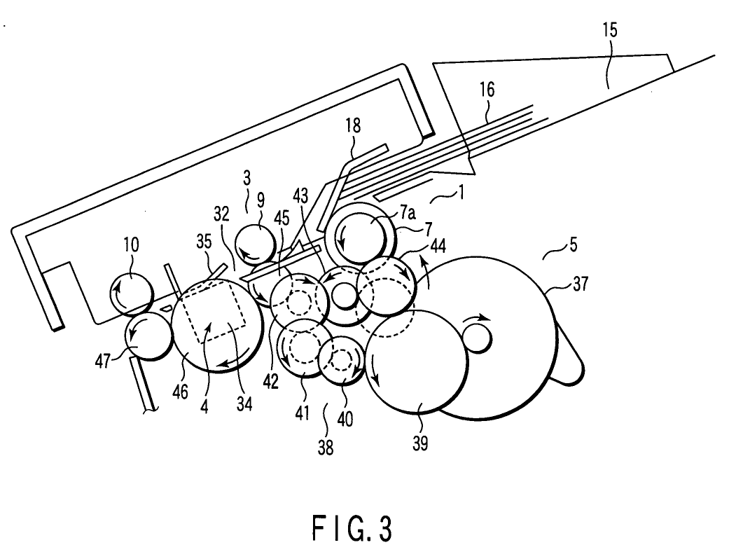

It is to be noted that, as shown in FIG. 3, a document image reading device is provided at the document sheet carrying path 32 onto which the document sheet is inserted from the document insertion section 17.

The image reading apparatus comprises a pick-up device 1 configured to pick up the set document sheets one by one from the document rest 15, a carrying device 3 configured to allow the document sheet which is picked up by the pick-up device 1 to be carried along the carrying path 32, the reading device 4 configured to allow the document sheet which is carried by the carrying device 3 to be read out, and a driving device 5 configured to drive the pick-up device 1 and carrying device 3.

The pick-up device 1 comprises a pick-up roller 7 and a separation pad 8 which is set in pressure contact with the upper surface portion of the pick-up roller 7. Through the rotation of the pick-up roller 7, the document sheets set on the document rest 15 are picked up one by one from a lower side.

The carrying device 3 has first and second carrying roller pairs 9 and 10 arranged such that these roller pairs are spaced a predetermined distance along a document sheet carrying direction. The document sheet is carried in a manner to be sandwiched by the first and second carrying roller pairs 9 and 10.

The document image reading device 4 is provided between the first and second carrying roller pairs 9 and 10 and is so structured as to have a reading sensor 34 for optically read out the document and a white color plate 35 arranged opposite to the reading sensor 34 through the carrying path.

The driving device 5 is so constructed that it has a driving motor 37 and a motive power transmission device 38 for transmitting a driving force of the driving motor 37 to the pick-up device 1 and carrying device 3.

The power transmission device 38 has continuously connected first to ninth power transmission gears 39 to 47. Of the first to ninth power transmission gears 39 to 47, the sixth power transmission gear 44 is connected to a gear 7a of the pick-up roller 7 and can be moved into contact with and away from the gear 7a.

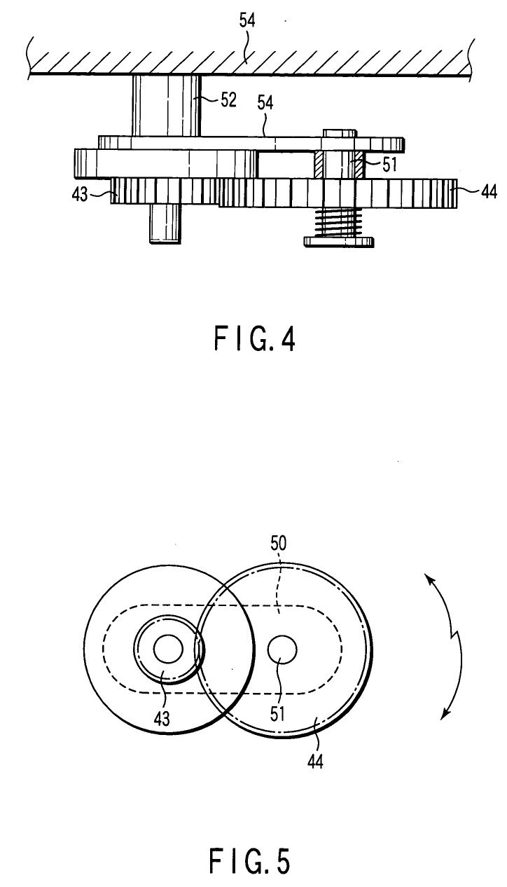

FIG. 4 is a plan view showing a mounting structure of the sixth power transmission gear 45 and FIG. 5 is a front view of that gear 45.

The sixth power transmission gear 44 is attached to a one-end portion of a rotation arm 50 through a support shaft 51. The other end portion of the rotation arm 50 is coaxially and rotatably supported relative to a support shaft 52 of the fifth power transmission gear 43. The support shaft 52 is mounted on a base 54.

Now an explanation will be made below about the document pick-up and read-out operations.

When the driving motor 37 is rotated, the first to ninth power transmission gears 39 to 47 are rotationally driven and the pick-up roller 7 and carrying roller pairs 9 and 10 are rotationally driven. Through the rotation of the pick-up roller 7, the document sheets 16 set on the document rest 15 are sent out and, while passing between the pick-up roller 7 and the separation pad 8, separated and picked up one by one. The picked-up document sheet 16, while being sandwiched by the first carrying roller pair 9, is carried and sent to the reading device 4. In the document image reading device 4, a document image is read out by the reading sensor 34. The document sheet from which the document image has been read out is delivered from the document discharge outlet 18 after being sandwiched by the second carrying roller pair 10.

At the document reading time, however, it is necessary that, in order to detect the document sheets one by one, the document sheet be carried while securing a distance between the document sheets. To this end, a speed difference is set between the document sheet pick-up speed in the pick-up device 1 and the document carrying speed in the image reading device 4. That is, the document pick-up speed in the pick-up device 1 is set to a first speed and the carrying speed for document image readout in the document image reading device 4 is set to a second speed faster than the first speed.

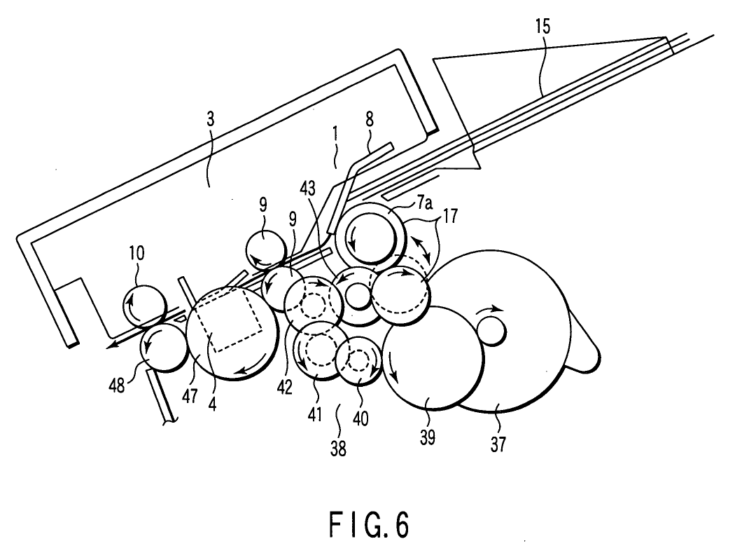

When the document sheet 16 which is picked up by the pick-up device 1 reaches the reading device 4 and is carried at a high speed, while being sandwiched by the carrying roller pairs 9 and 10, then the document sheet 16 is set to a state withdrawnable from between the pick-up roller 7 and the separation pad 8 in the pick-up device 1. The pick-up roller 7 is rotated together at a higher speed than at a pick-up speed of the document sheet, and the contactable gear 45 is flipped away from the gear 7a of the pick-up roller 7 as shown in FIG. 6. By doing so, the rotation arm 50 is rotated downward about the support shaft 52 to cause the gear 45 to be spaced away from the gear 7a. As a result, the pick-up roller 7 and power transmission device 38 are disconnected and the step-out, etc., of the driving motor 37 is prevented.

When the document sheet 15 is completely sent out from the pick-up roller 7, the rotating together of the pick-up roller 7 is stopped and the gear 45 is again connected to the gear 7a of the pick-up roller 7.

As set out above, when the document sheet 15 picked up through the rotation of the pick-up roller 7 reaches the carrying roller pairs 9 and 10 and is carried in a sandwiched fashion and, by doing so, the document sheet is withdrawn at the higher speed from the pick-up roller, the gear 45 is moved away from the gear 7a of the pick-up roller 7. As a result, the gear 7a of the pick-up roller 7 and power transmission device 38 can be disconnected.

This obviates the necessity to use any expensive one-way crutch and it is yet possible to disconnect the gear 7a of the pick-up roller 7 from the power transmission device 38 and to reduce a cost involved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A carrying apparatus comprising:
a pick-up device which allows medium sheets to pass between a pick-up roller and a separation pad set in pressure contact with the pick-up roller and, by doing so, separates and picks up the sheets one by one at a first speed;
a carrying device which allows the sheet which is picked up by the pick-up device to be sandwiched by carrying roller pairs and carried at a second speed higher than at the first speed; and
a driving device which has a driving source and a plurality of continuous power transmission gears adapted to transmit a motive power of the driving source to the pick-up roller and carrying roller pairs where, of said plurality of continuous motive power transmission gears, a motive power transmission gear connected directly to the pick-up roller is moved away from the pick-up roller based on the withdrawing of the sheet at said second speed from between the pick-up roller and the separation pad.

2. A carrying apparatus according to claim 1, wherein said motive power transmission gear moved away from the pick-up roller is again connected to the pick-up roller based on the passing of the sheet between the pick-up roller and the separation pad.

3. A carrying apparatus according to claim 2, wherein the motive power transmission gear moved away from the pick-up roller is mounted at a rotation end portion of a rotation arm.

4. A carrying apparatus according to claim 1, wherein the sheet which is picked up at said first speed is carried at said second speed by being sandwiched by said carrying roller pairs to provide a predetermined spacing relative to a subsequent medium sheet.

5. An image reading apparatus comprising:
a pick-up device which allows medium sheets to pass between a pick-up roller and a separation pad set in pressure contact with the pick-up roller and, by doing so, separates and picks up the sheets one by one at a first speed;
a carrying device which allows the sheet which is picked up by the pick-up device to be sandwiched by carrying roller pairs and carried at a second speed higher than at the first speed;
a driving device which has a driving source and a plurality of continuous motive power transmission gears adapted to transmit a motive power of the driving source to the pick-up roller and carrying roller pairs where, of said plurality of continuous motive power transmission gears, a motive power transmission gear connected directly to the pick-up roller is moved away from the pick-up roller based on the withdrawing of the sheet at said second speed from between the pick-up roller and the separation pad; and
a reading device which reads out information of the medium sheet carried by the carrying device in a sandwiched fashion.

6. An image reading apparatus according to claim 5, wherein said motive power transmission gear moved away from the pick-up roller is again connected to the pick-up roller based on the passing of the sheet between the pick-up roller and the separation pad.

7. An image reading apparatus according to claim 6, wherein said motive power transmission gear moved away from the pick-up roller is mounted at a rotation end portion of a rotation arm.

8. An image reading apparatus according to claim 5, wherein the sheet which is picked up at said first speed is carried at said second speed by being sandwiched by said carrying roller pairs to provide a predetermined spacing relative to a subsequent medium sheet.

9. An image forming apparatus comprising:
a pick-up device which allows medium sheets to pass between the pick-up roller and a separation pad set in pressure contact with the pick-up roller and, by doing so, separates and picks up the sheets one by one at a first speed;
a carrying device which allows the sheet which is picked up by the pick-up device to be sandwiched by carrying roller pairs and carried at a second speed higher than at said first speed;
a driving device which has a driving source and a plurality of continuous motive power transmission gears adapted to transmit a motive power of the driving source to the pick-up roller and carrying roller pairs where, of said plurality of continuous motive power transmission gears, a motive power transmission gear connected directly to the pick-up roller is moved away from the pick-up roller based on the withdrawing of the sheet at said second speed from between the pick-up roller and the separation pad;
a reading device which reads out information on the medium sheet carried by the carrying device in a sandwiched fashion; and
an image forming device which forms an image on a recording medium based on the information read out by the reading device.

10. An image forming apparatus according to claim 9, wherein said motive power transmission gear moved away from the pick-up roller is again connected to the pick-up roller based on the passing of the sheet between the pick-up roller and the separation pad.

11. An image forming apparatus according to claim 10, wherein said motive power transmission gear moved away from the pick-up roller is mounted at the rotation end portion of a rotation arm.

12. An image forming apparatus according to claim 9, wherein the document sheet which is picked up at said first speed is carried at said second speed by being sandwiched by said carrying roller pairs to provide a predetermined spacing relative to a subsequent medium sheet.
